(19) United States
(12) Patent Application Publication
(10) Pub. No.: US 2019/0318587 A1
(43) Pub. Date: Oct. 17, 2019

(54) COMMODITY SALES DATA PROCESSING APPARATUS

(71) Applicant: TOSHIBA TEC KABUSHIKI KAISHA, Tokyo (JP)

(72) Inventor: Yusuke ABURAYA, Sunto Shizuoka (JP)

(21) Appl. No.: 16/377,592

(22) Filed: Apr. 8, 2019

(30) Foreign Application Priority Data
Apr. 12, 2018 (JP) 2018-076804

(51) Int. Cl. G07G 1/00; G06F 3/16; H04R 5/04; H04R 5/02; G07G 1/12

(52) U.S. Cl. CPC G07G 1/0018; G06F 3/167; G07G 1/12; G06F 3/165; H04R 5/02; H04R 5/04

(57) ABSTRACT

A commodity sales data processing apparatus includes first and second audio generators and a control device. The first audio generator is directed toward a first side, connected to a first stereophonic audio channel, and configured to generate a first stereophonic audio output based on a first part of a stereophonic audio signal. The second audio generator is directed toward a second side, connected to a second stereophonic audio channel, and configured to generate a second stereophonic audio output based on a second part of the stereophonic audio signal. The control device is configured to select a stereophonic audio data file, determine first and second volumes of the first and second audio generators, respectively, based on the stereophonic audio data file, and control the first and second audio generators to generate first and second stereophonic audio outputs corresponding to the selected stereophonic audio file, at the first and second volumes, respectively.

### CROSS-REFERENCE TO RELATED APPLICATION

This application is based upon and claims the benefit of priority from Japanese Patent Application No. 2018-076804, filed on Apr. 12, 2018, the entire contents of which are incorporated herein by reference.

### FIELD

An embodiment described herein relates generally to a commodity sales data processing apparatus.

### BACKGROUND

A POS (Point of Sales) terminal that performs registration processing for registering commodity information of commodities purchased by a customer and settlement processing based on the registered commodity information is provided in a retail store such as a supermarket or a convenience store. In order to smoothly carry out the registration processing and the settlement processing, such a POS terminal may provide, with voice, an operation request, an operation guide, and the like to an operator who operates the POS terminal, and a customer who purchases commodity.

However, the POS terminal in a related art outputs such voice messages from a sound output device (e.g., speaker) directed to the operator and a sound output device directed to the customer. In this case, voice data is output to the speakers via voice output sections, provided independently at the operator side and the customer side, control the voice output. Such a conventional POS terminal includes two independent voice output systems. For this reason, a large number of components may be required, resulting in an increased cost and a complicated structure of the apparatus.

### DESCRIPTION OF THE DRAWINGS

FIGS. 1A and 1B illustrate perspective views of a POS terminal according to an embodiment.

FIG. 2 is a block diagram illustrating a hardware arrangement of the POS terminal shown in FIG. 1.

FIG. 3 is a block diagram illustrating functional components of a control section of the POS terminal.

FIG. 4 is a schematic diagram illustrating a sound output section of the POS terminal.

FIG. 5 is a conceptual diagram illustrating a header file stored in a sound file together with a sound source data.

FIG. 6 is a diagram illustrating contents of a specific sound output from the POS terminal.

FIG. 7 is a flowchart illustrating registration processing and settlement processing performed by the control section of the POS terminal.

FIG. 8 is a flowchart illustrating sound output processing performed by a sound output section of the POS terminal.

### DETAILED DESCRIPTION

According to an embodiment, a commodity sales data processing apparatus includes first and second audio generators and a control device. The first audio generator is directed toward a first side of the commodity sales data processing apparatus, connected to a first stereophonic audio channel for transmitting a first part of a stereophonic audio signal, and configured to generate a first stereophonic audio output based on the first part of the stereophonic audio signal. The second audio generator is directed toward a second side of the commodity sales data processing apparatus different from the first side, connected to a second stereophonic audio channel for transmitting a second part of the stereophonic signal, and configured to generate a second stereophonic audio output based on the second part of the stereophonic audio signal. The control device is configured to select a stereophonic audio data file from a plurality of stereophonic audio data files, determine a first volume of the first audio generator and a second volume of the second audio generator based on the selected stereophonic audio data file, and control the first audio generator to generate a first stereophonic audio output corresponding to the selected stereophonic audio file at the first volume and the second audio generator to generate a second stereophonic audio output corresponding to the selected stereophonic audio file at the second volume.

A POS terminal according to an embodiment is described with reference to the accompanying drawings. The POS terminal according to the present embodiment is provided in a retail store such as a supermarket or a convenience store. A customer faces an operator, who operates the POS terminal, to request the operator to perform settlement of commodities for purchase when the customer takes commodities to a settlement place. The operator operates the POS terminal to perform registration processing and settlement processing for the commodities by the POS terminal. The embodiment described hereinafter is applied to a POS terminal as a commodity sales data processing apparatus.

Overall Feature of POS Terminal

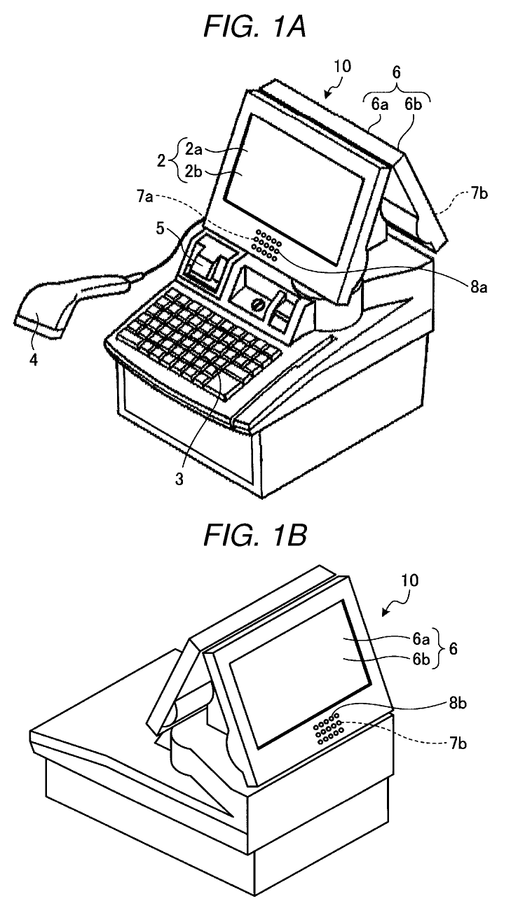

FIGS. 1A and 1B are perspective views of a POS terminal 10 according to the present embodiment. As illustrated in FIG. 1A, the POS terminal 10 includes an operator-side display operation section 2, an operator-side speaker 7a, a keyboard 3, a barcode reader 4, a receipt printer 5, a customer-side display operation section 6, and a customer-side speaker 7b.

The operator-side display operation section 2 and the keyboard 3, i.e., user interfaces, are disposed on the upper surface of the POS terminal 10 such that the keyboard 3 is arranged at the front side and the operator-side display operation section 2 arranged at the rear side.

The keyboard 3 includes a plurality of keys such as a numeric key, a clear key, a return key, a subtotal key, and a closing key. The numeric key includes numeric keys for inputting numerical characters such as a commodity code and an amount. The clear key is used for cancelling operation if an error occurs. The return key is used for cancelling a present operation and returning to a preceding screen displayed immediately before the cancelled operation. The subtotal key is used for declaring completion of the registration processing to calculate a total amount of the transaction. The closing key is used for determining a deposited amount to start settlement processing.

The operator-side display operation section 2 includes a display device such as an LCD (Liquid Crystal Display) panel 2a and a touch panel 2b laminated on the surface of the display device. The LCD panel 2a displays screens corresponding to processing states such as registration processing and settlement processing to an operator (store clerk). The touch panel 2b detects a press-operation of the operator on a screen or a button on the screen displayed on the LCD panel 2a to control the operation of the POS terminal 10 according to a position on the screen pressed by the operator.

The operator-side speaker 7a is provided in the vicinity of the operator-side display operation section 2 such that it is directed toward the operator. The operator-side speaker 7a outputs sound or voice corresponding to the processing states or progress of the processing such as the registration processing and the settlement processing to the operator through sound holes 8a. The operator-side speaker 7a is an example of the first output section. A setting position of the operator-side speaker 7a is not limited to the vicinity of the operator-side display operation section 2. The operator-side speaker 7a may be set at any position as long as it is directed toward the operator side.

The receipt printer 5 is arranged at the left side on the upper surface of the POS terminal 10. The receipt printer 5 prints a detailed statement slip and a receipt to issue the printed receipt to be handed to the customer.

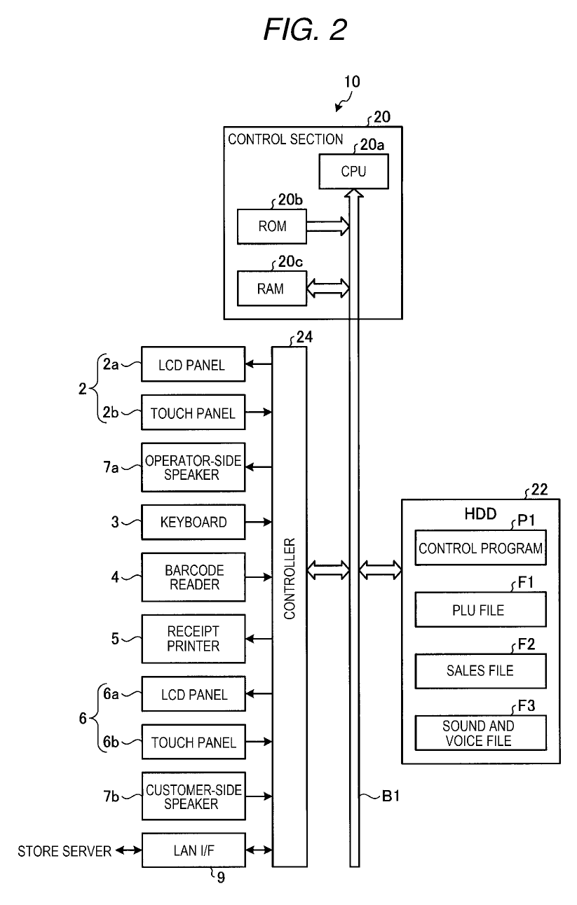

The barcode reader 4 that reads, from a barcode attached to a commodity, a code data of the barcode is connected to the POS terminal 10. The barcode reader 4 outputs light to the barcode and decodes a light signal received from the barcode, acquires code data (commodity code for specifying commodity) represented by the barcode, and outputs the code data to a CPU 20a (see FIG. 2) of the POS terminal 10.

The customer-side display operation section 6 includes a display device such as an LCD panel 6a and a touch panel 6b laminated on the surface of the display device. The LCD panel 6a displays screens corresponding to processing states or progress of the processing such as registration processing and settlement processing to the customer. The LCD panel 6a displays name, number, unit price, total amount, and the like of a commodity at the time of registering the commodity. The touch panel 6b detects a press-operation of the customer on a screen or a button on the screen displayed on the LCD panel 6a to control the operation of the POS terminal 10 according to a position on the screen pressed by the customer.

As illustrated in FIG. 1B, the customer-side speaker 7b is provided in the vicinity of the customer-side display operation section 6 such that it is directed toward the customer. The customer-side speaker 7b outputs sound or voice corresponding to the processing states such as the registration processing and the settlement processing to the customer through sound holes 8b. The customer-side speaker 7b is an example of the second output section. A setting position of the customer-side speaker 7b is not limited to the vicinity of the customer-side display operation section 6. The customer-side speaker 7b may be set at any position as long as it is directed toward the customer side.

Hardware of POS Terminal

A hardware structure of the POS terminal 10 is described with reference to FIG. 2. FIG. 2 is a block diagram illustrating a hardware constitution of the POS terminal 10 according to the present embodiment. As illustrated in FIG. 2, the POS terminal 10 includes a control section 20 that executes registration processing and settlement processing according to a transaction of commodities.

The control section 20 includes a general computer including a CPU (Central Processing Unit) 20a, a ROM (Read Only Memory) 20b, and a RAM (Random Access Memory) 20c. The CPU 20a reads out various computer programs, data files, and the like stored in the ROM 20b and an HDD (Hard Disk Drive) 22 described below to develop or copy the various computer programs, the data files, and the like on the RAM 20c. The CPU 20a operates according to the various computer programs, the data files, and the like developed or copied on the RAM 20c to control the entire POS terminal 10.

The HDD 22 retains stored information even if an electric power is turned off. Instead of the HDD 22, the POS terminal 10 may include a nonvolatile memory such as a flash memory. The HDD 22 stores computer programs and the like including a control program P1. The control program P1 is a program for performing functions of the POS terminal 10. The control program P1 may be incorporated in the ROM 20b in advance to be provided. The control program P1 may be recorded in a computer-readable recording medium such as a CD-ROM, a flexible disk (FD) , a CD-R, or a DVD (Digital Versatile Disc) as a file of a form installable in the control section 20 or an executable form and provided. Further, the control program P1 may be stored on a computer connected to a network such as the Internet and provided by being downloaded through the network. The control program P1 may be provided or distributed through the network such as the Internet.

The HDD 22 stores a PLU (Price Look Up) file F1, a sales file F2, and a sound file F3.

The PLU file F1 stores code information of JAN code uniquely allocated to a commodity in association with commodity information concerning the commodity such as a name, a unit price, and a commodity category. The POS terminal 10 periodically receives the latest PLU file F1 from a store server via a LAN I/F (Local Area Network Interface) 9 to update the stored PLU file F1 day after day.

The sales file F2 stores commodity registration information generated by the control section 20 performing registration processing of a commodity.

The sound file F3 registers sound to be output to the operator or the customer according to a state of a performed processing at the time the control section 20 performs the registration processing and the settlement processing. Specifically, sound source data of a WAV format, an MP3 format, or the like is stored in the sound file F3. The sound file F3 is described in detail below.

A controller 24 connects the control section 20 with various peripheral devices, e.g., the operator-side display operation section 2 (LCD panel 2a and touch panel 2b) described above, the keyboard 3, the barcode reader 4, the receipt printer 5, the customer-side display operation section 6 (LCD panel 6a and touch panel 6b), the operator-side speaker 7a, the customer-side speaker 7b, and the LAN I/F 9. The controller 24 controls the operation of the connected various peripheral devices on the basis of a command from the control section 20.

Function of POS Terminal

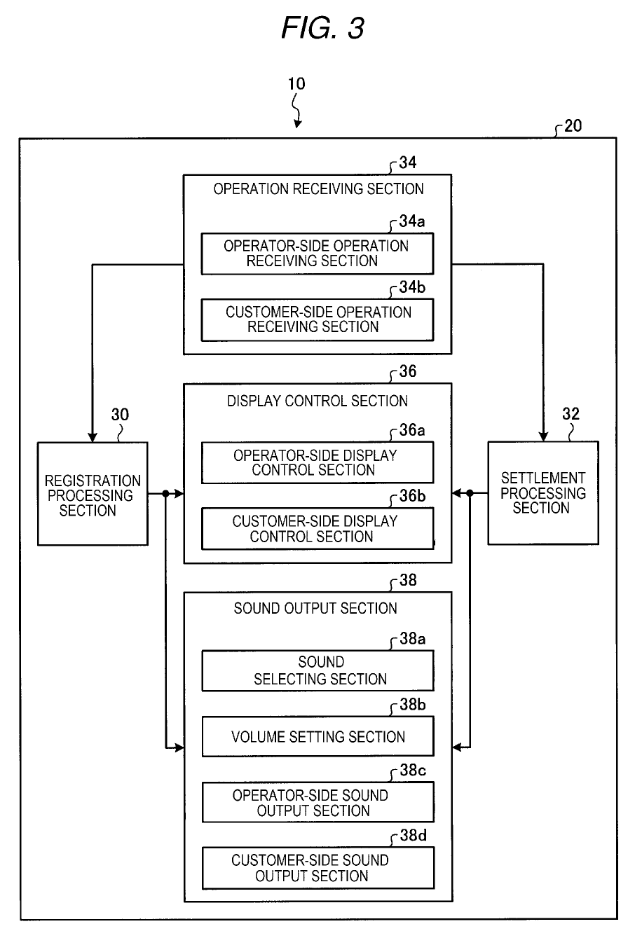

A functional structure of the POS terminal 10 is described with reference to FIG. 3. FIG. 3 is a block diagram illustrating a functional constitution of the control section 20 of the POS terminal 10 according to the present embodiment.

The control program P1 executed by the POS terminal 10 in the present embodiment is composed of, as illustrated in FIG. 3, modules including a registration processing section 30, a settlement processing section 32, an operation receiving section 34, a display control section 36, and a sound output section 38. The CPU 20a reads out the control program P1 from the HDD 22, develops the control program P1 on the RAM 20c, and executes the control program P1 to server as each section illustrated in FIG. 3, as actual hardware, in the control section 20. Further, functional units that control the various peripheral devices illustrated in FIG. 2 are achieved by the control section 20. However, only units relating to a function for outputting sound or voice at the time the POS terminal 10 performs the registration processing and the settlement processing are illustrated in FIG. 3.

The registration processing section 30 performs registration processing for registering, in the sales file F2 of the HDD 22, commodity information of a commodity specified by code data (commodity code) represented by barcode read by the barcode reader 4.

The settlement processing section 32 performs settlement processing for the commodity registered in the registration processing to complete payment. Specifically, the settlement processing section 32 calculates a total amount of the commodities registered by the registration processing section 30 to display the total amount. The settlement processing section 32 subtracts the total amount from an amount received from the customer to provide a change amount.

The operation receiving section 34 receives information of operation performed on the operator-side display operation section 2 (touch panel 2b), the keyboard 3, and the customer-side display operation section 6 (touch panel 6b) at the time the control section 20 performs the registration processing and the settlement processing.

The operation receiving section 34 includes an operator-side operation receiving section 34a and a customer-side operation receiving section 34b. The operator-side operation receiving section 34a receives operation on the touch panel 2b and the keyboard 3. The customer-side operation receiving section 34b receives operation on the touch panel 6b.

The display control section 36 controls display states of various screens displayed on the operator-side display operation section 2 (LCD panel 2a) and the customer-side display operation section 6 (LCD panel 6a) at the time the control section 20 performs the registration processing and the settlement processing.

The display control section 36 includes an operator-side display control section 36a and a customer-side display control section 36b. The operator-side display control section 36a controls display states of various screens displayed on the LCD panel 2a. The customer-side display control section 36b controls display states of various screens displayed on the LCD panel 6a.

The sound output section 38 selects, out of the sound file F3, sound or voice to be output from the operator-side speaker 7a and the customer-side speaker 7b. The sound output section 38 outputs the selected sound or voice through the operator-side speaker 7a or the customer-side speaker 7b.

The sound output section 38 includes a sound selecting section 38a, a volume setting section 38b, an operator-side sound output section 38c, and a customer-side sound output section 38d.

The sound selecting section 38a selects, according to the progress of the registration processing and the settlement processing, sound or voice output to the operator side or the customer side from sounds and voices prepared in advance. The sound selecting section 38a is an example of the selecting module.

The volume setting section 38b sets, for each sound or voice, volume for outputting the sound or the voice selected by the sound selecting section 38a from the operator-side speaker 7a and a volume for outputting the sound or the voice selected by the sound selecting section 38a from the customer-side speaker 7b. The volume setting section 38b is an example of the volume setting module.

The operator-side sound output section 38c is connected to one of the channels of a stereo voice signal to output the sound or voice selected by the sound selecting section 38a to the operator side. The customer-side sound output section 38d is connected to the other channel of the stereo voice signal to output the sound or the voice selected by the sound selecting section 38a to the customer side.

Method for Outputting Sound and Voice

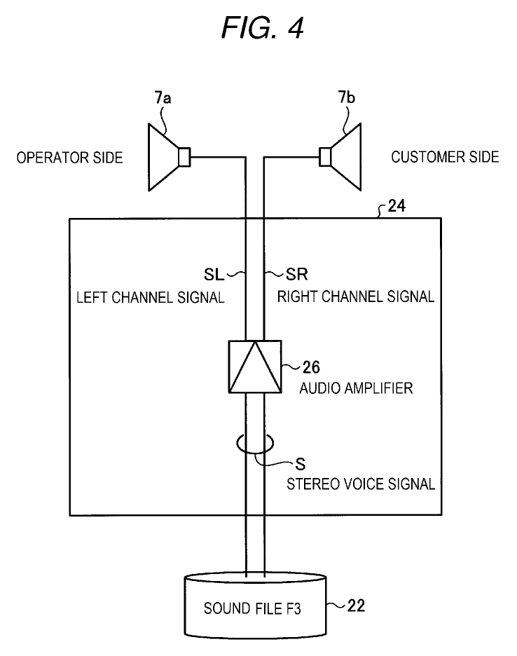

A method for outputting sound or voice to the operator side or the customer side by the control section 20 of the POS terminal 10 is described with reference to FIG. 4. FIG. 4 is a diagram illustrating a hardware structure for outputting sound or voice through the operator-side speaker 7a and the customer-side speaker 7b in the POS terminal 10 according to the present embodiment.

Sound or voice data to be output is stored in the HDD 22 as a sound file F3. The sound file F3 readout by the sound selecting section 38a (see FIG. 3) is output to the controller 24 in a form of a stereo voice signal S. The stereo voice signal S is composed of a left channel signal SL and a right channel signal SR.

The controller 24 includes an audio amplifier 26 that amplifies volume of the stereo voice signal S at left and right channels at a predetermined amplification rate. A method of setting volume of the stereo voice signal S is described below.

The left channel signal SL of the stereo voice signal S amplified by the audio amplifier 26 is connected to, for example, the operator-side speaker 7a. The left channel signal SL is output from the operator-side speaker 7a to the operator as a sound.

The right channel signal SR of the stereo voice signal S amplified by the audio amplifier 26 is connected to, for example, the customer-side speaker 7b. The right channel signal SR is output from the customer-side speaker 7b to the customer as a sound.

In FIG. 4, it is described that the left channel signal SL is connected to the operator-side speaker 7a and the right channel signal SR is connected to the customer-side speaker 7b. However, combinations of the channels of the stereo voice signal S and the speakers to which the channels are connected are not limited to the above. The left channel signal SL may be connected to the customer-side speaker 7b and the right channel signal SR may be connected to the operator-side speaker 7a.

Method of Setting Volume and Output Destination of Sound or Voice

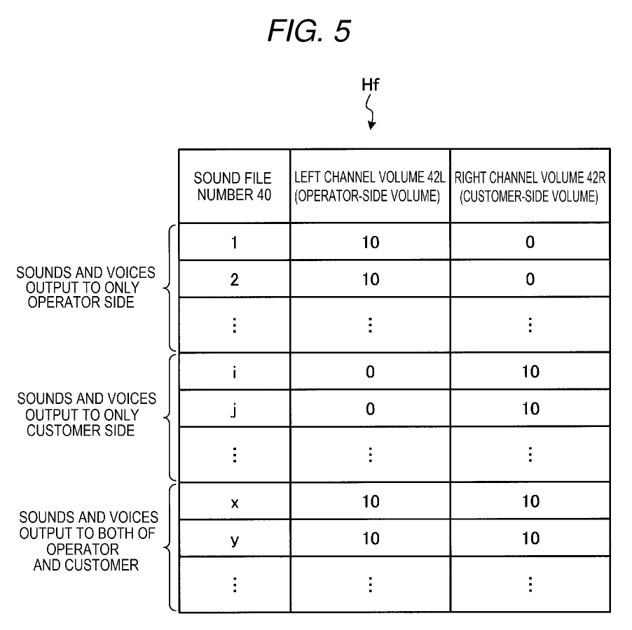

A method of setting volume and an output destination of sound or voice is described with reference to FIG. 5. FIG. 5 is a conceptual diagram illustrating a header file Hf stored in the sound file F3 together with sound source data.

In the header file Hf, a sound file number 40, a left channel volume 42L, and a right channel volume 42R are registered. The header file Hf is an example of a data file.

The sound file number 40 is an identification number for uniquely specifying the sound source data stored in the sound file F3.

The left channel volume 42L and the right channel volume 42R are defined as an output balance of both the channels of the stereo voice signal S.

Specifically, the left channel volume 42L is information for specifying volume of the left channel at the time the stereo voice signal S is amplified by the audio amplifier 26. In the present embodiment, the left channel volume 42L is set as an integer value, for example, between 0 (minimum) to 10 (maximum).

The right channel volume 42R is information for specifying volume of the right channel at the time the stereo voice signal S is amplified by the audio amplifier 26. In the present embodiment, the right channel volume 42R is set as an integer value, for example, between 0 (minimum) to 10 (maximum).

In the header file Hf illustrated in FIG. 5, sound source data, of which the left channel volume 42L is set to “10” and the right channel volume 42R is set to “0”, is assigned with identification numbers 1, 2, . . . , as the sound file number 40. Sound source data with the volume “10” is amplified by the audio amplifier 26 to be output from the operator-side speaker 7a. Sound source data with the volume “0” is amplified by the audio amplifier 26 to be output from the customer-side speaker 7b. That is, audible sound or voice is output from only the operator-side speaker 7a.

In this way, in the present embodiment, the same sound source data as that output from the operator-side speaker 7a is output with the volume “0” from the customer-side speaker 7b, which outputs no sound or voice. That is, it is unnecessary to select the operator-side speaker 7a or the customer-side speaker 7b, i.e., output port of sound, for each sound source data to be output.

An output destination of sound can be selected on the basis of only the balance of the left and right channels defined in the header file Hf.

Similarly, in the header file Hf illustrated in FIG. 5, sound source data, of which the left channel volume 42L is set to “0” and the right channel volume 42R is set to “10”, is assigned with identification numbers i, j, . . . , as the sound file number 40. Sound source data with the volume “0” is amplified by the audio amplifier 26 to be output from the operator-side speaker 7a. Sound source data with the volume “10” is amplified by the audio amplifier 26 to be output from the customer-side speaker 7b. That is, audible sound or voice is output from only the customer-side speaker 7b.

Further, in the header file Hf illustrated in FIG. 5, sound source data is assigned with identification numbers x, y, . . . , as the sound file number 40, the left channel volume 42L thereof is set to “10” and the right channel volume 42R thereof is set to “10”. Sound source data with the volume “10” is amplified by the audio amplifier 26 to be output from the operator-side speaker 7a. Sound source data with the volume “10” is amplified by the audio amplifier 26 to be output from the customer-side speaker 7b. That is, audible sound or voice is output to both of the operator side speaker 7a and the customer side speaker 7b. As shown in FIG. 5, the sound or voice is output to both of the operator side speaker 7a and the customer side speaker 7b at the same volume “10”. However, the volume may be differentiated between the operator side and the customer side as needed. For example, in the case of sound or voice that mainly the operator has to hear, the volume of the sound source output to the customer side speaker may be reduced. In the case of sound or voice that mainly the customer has to hear, the volume of the sound source output to the operator side may be reduced.

The sound or voice the same as that output to only the customer side (sound source data assigned with the identification numbers i, j, . . . , as the sound file number 40) may also be output to the operator side. Consequently, content of the sound or voice output to the customer side is transmitted to the operator side as well. The operator can predict a behavior in an operation of the customer. Therefore, even if the customer is confused what to do next in the operation, the operator can immediately assist the customer. At this point, volume of the sound or voice output to the operator side is desirably set smaller than that output to the customer side, considering a master-slave relation (priority in notification) of the output destinations of the sound or voice. For example, by setting the right channel volume 42R to “10” and setting the left channel volume 42L to “5” in the header file Hf, the sound or voice the same as that output to the customer side can be output to the operator side with a smaller volume. Similarly, sound or voice output to only the operator side may be output to the customer side.

In the header file Hf illustrated in FIG. 5, sound or voice output to only the operator side, sound or voice output to only the customer side, and sound or voice output to both of the operator side and the customer side are respectively registered as each group. However, the registering order is not limited to the above. Respective sounds or voices may be registered in the header file Hf in random order. Therefore, new sound or voice can be easily added to the header file Hf and sound or voice which is not necessary anymore in an operation and the like can be easily deleted from the header file Hf.

Sound and Voice

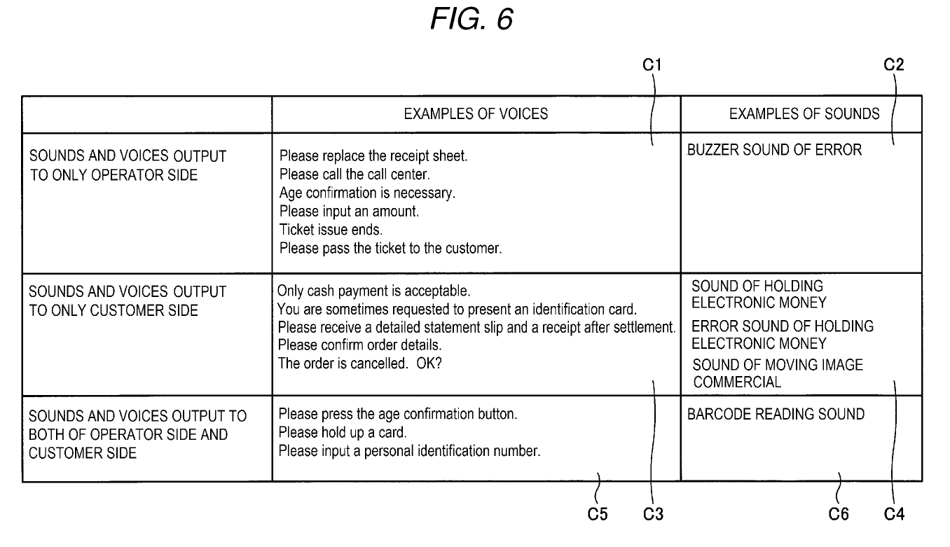

A specific example of sound and voice output by the POS terminal 10 is described with reference to FIG. 6. FIG. 6 is a diagram illustrating a specific example of sound and voice output to the operator side or the customer side by the POS terminal 10.

Voices output to only the operator side are shown in a cell C1. Sounds output to only the operator side are shown in a cell C2. As shown in the cell C1, the voices output to only the operator side include an operation guide necessary in performing the registration processing and the settlement processing. The sounds output to only the operator side include sound indicating occurrence in errors such as an operation error by the operator and a scanning error by the barcode reader 4.

Voices output to only the customer side are shown in a cell C3. Sounds output to only the customer side are shown in a cell C4. As shown in the cell C3, the voices output to only the customer side include voices for guiding the customer in an operation. The sounds output to only the customer side include sound for guiding the customer in operation and sound relating to a commercial.

Voices output to both of the operator side and the customer side are shown in a cell C5. Sounds output to both of the operator side and the customer side are shown in a cell C6. As shown in the cell C5, the voices output to both of the operator side and the customer side include voices for requesting the customer to perform operation. This is because, if the customer is requested to perform operation, the customer is likely to be unable to decide operation, on the other hand, if the operator knows beforehand what kind of operation the customer has to perform next, the operator can assist the operation by the customer as needed. The sounds output to both of the operator and the customer include sound generated in response to the operation of the operator. Such a sound can inform the customer surely that the operator is performing, for example, operation of the commodity registration. The customer feels reassured when he or she hears the sound.

Flow of registration processing and settlement processing

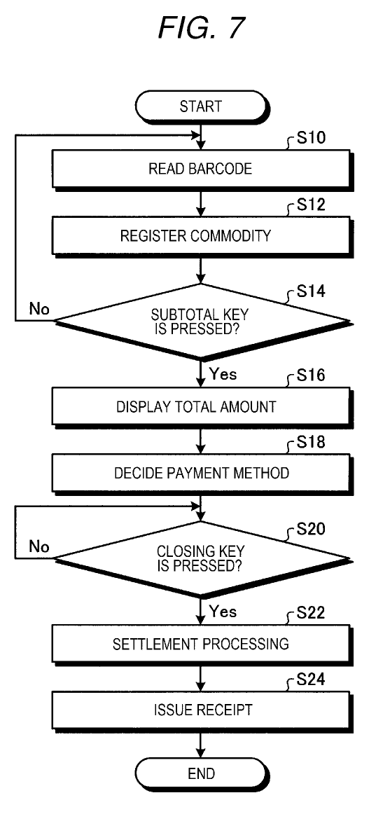

A flow of the registration processing and the settlement processing performed by the control section 20 of the POS terminal 10 is described with reference to FIG. 7. FIG. 7 is a flowchart illustrating the flow of the registration processing and the settlement processing performed by the control section 20 of the POS terminal 10 according to the present embodiment. The flowchart of FIG. 7 shows a flow of processing after the control section 20 starts the registration processing on the basis of an operation instruction of the operator-side operation receiving section 34a.

First, the registration processing section 30 reads a barcode attached to a commodity with the barcode reader 4 (Act 10).

Subsequently, the registration processing section 30 registers, in the sales file F2, a commodity indicated by code data represented by the barcode read in Act 10 (Act 12).

The operation receiving section 34 determines whether the subtotal key on the keyboard 3 is pressed (Act 14). If it is determined that the subtotal key is pressed (Yes in Act 14), processing in Act 16 is executed. On the other hand, if it is determined that the subtotal key is not pressed (No in Act 14), the processing in Act 10 is re-executed.

The registration processing section 30 calculates a total amount of registered commodities if the subtotal key is pressed. The display control section 36 displays the total amount on the LCD panels 2a and 6a (Act 16).

The settlement processing section 32 determines a payment method (Act 18). Specifically, the settlement processing section 32 determines a payment method such as cash payment or card payment according to an input from the touch panel 6b operated by the customer or an input from the touch panel 2b operated by the operator according to an instruction from the customer.

The settlement processing section 32 determines whether the closing key on the keyboard 3 is pressed (Act 20). If it is determined that the closing key is pressed (Yes in Act 20), processing in Act 22 is executed. On the other hand, if it is determined that the closing key is not pressed (No in Act 20), the settlement processing section 32 repeats the determination in Act 20.

The settlement processing section 32 performs the settlement processing if the closing key is pressed (Act 22).

The settlement processing section 32 issues a receipt by the receipt printer 5 (Act 24). Thereafter, the settlement processing section 32 ends the settlement processing.

Flow of Informing Processing

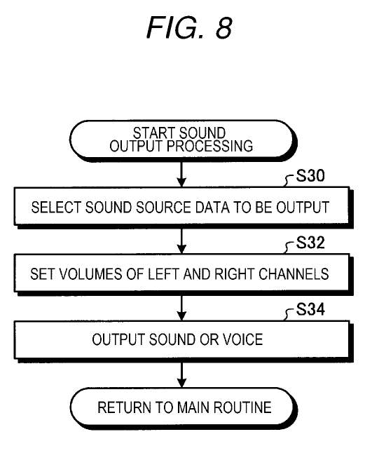

A flow of sound output processing is described with reference to FIG. 8. FIG. 8 is a flowchart illustrating a flow of sound output processing performed by the sound output section 38 of the POS terminal 10 according to the present embodiment.

If a sound output is required while the control section 20 is performing the registration processing and the settlement processing described above, the sound output section 38 executes the processing illustrated in FIG. 8.

First, the sound selecting section 38a selects a sound source data to be output from the sound file F3 (Act 30).

Subsequently, the volume setting section 38b sets volumes of the left and right channels (Act 32). In the present embodiment, the left channel is a passage of sound or voice output to the operator side and the right channel is a passage of sound or voice output to the customer side.

Subsequently, the operator-side sound output section 38c outputs the sound source data with the volume set in Act 32 selected in Act 30 to the operator-side speaker 7a. The customer-side sound output section 38d outputs the sound source data with the volume set in Act 32 selected in Act 30 to the customer-side speaker 7b (Act 34). Thereafter, the sound output section 38 ends the sound output processing. The processing in the flowchart (main routine) shown in FIG. 7 is executed.

As described above, in the POS terminal 10 (commodity sales data processing apparatus) according to the present embodiment, the sound selecting section 38a (selecting module) selects, according to the operation of the operator, sound or voice output to the operator or the customer from the sounds or the voices prepared in advance. The volume setting section 38b (volume setting module) sets, for each sound or voice, volume for outputting the sound or the voice selected by the sound selecting section 38a from the operator-side speaker 7a (first output section) connected to one of the channels of the stereo voice signal and volume for outputting the sound or the voice from the customer-side speaker 7b (second output section) connected to the other channel of the stereo voice signal. Therefore, a voice guide suitable for the operator and the customer can be carried out with a simple constitution.

In the POS terminal 10 according to the present embodiment, the volume setting section 38b sets, for each sound or voice selected by the sound selecting section 38a, the output balance of both the channels of the stereo voice signal. Therefore, volume of the sound or the voice output to the operator side and volume of the sound or the voice output to the customer side can be easily set by adjusting right and left volume balance of the stereo voice signal.

In the POS terminal 10 according to the present embodiment, the volume setting section 38b sets, for each sound or voice prepared in advance, the output balance of the right and left channels on the basis of the header file Hf (data file) that defines the output balance of both the channels of the stereo voice signal. Therefore, if a volume change is required, the volume can be easily changed by rewriting the header file Hf.

In the POS terminal 10 according to the present embodiment, the volume setting section 38b sets the volume of the sound or the voice output from the operator-side speaker 7a such that it is smaller than that from the customer-side speaker 7b at the time of outputting the same sound or voice selected by the sound selecting section 38a from both the operator-side speaker 7a and the customer-side speaker 7b, simultaneously. The sound or the voice output to the customer side can be transmitted to the operator side as well. Therefore, the operator can predict a behavior in an operation of the customer. For example, if the customer is confused in the operation, the operator can immediately assist the customer.

In the POS terminal 10 according to the present embodiment, the operator-side speaker 7a is directed to the operator side and the customer-side speaker 7b is directed to the customer side. Therefore, the speakers can be set at respective positions at which the operator and the customer can easily hear the sound or the voice from the respective speakers.

In a modification of the POS terminal 10 according to the present embodiment, in a case in which voice or sound from the speaker cannot be heard clearly because of announcement for advertisement, communication for store clerk, or the like in the store, a volume adjusting function, e.g., software volume function, is provided to the audio amplifier 26 of the controller 24 and volume of the voice or the sound may be adjusted in a software manner. In this case, for example, the operator selects a volume adjustment menu displayed on the LCD panel 2a to adjust the volume of the right channel signal SR and the volume of the left channel signal SL, simultaneously or independently. Even if the volume adjustment is performed on the audio amplifier 26, the volume of a sound source data of which the volume is set to “0” in the header file Hf remains “0”.

While certain embodiments have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A commodity sales data processing apparatus comprising:
a first audio generator directed toward a first side of the commodity sales data processing apparatus, connected to a first stereophonic audio channel for transmitting a first part of a stereophonic audio signal, and configured to generate a first stereophonic audio output based on the first part of the stereophonic audio signal;
a second audio generator directed toward a second side of the commodity sales data processing apparatus different from the first side, connected to a second stereophonic audio channel for transmitting a second part of the stereophonic signal, and configured to generate a second stereophonic audio output based on the second part of the stereophonic audio signal; and
a control device configured to:
select a stereophonic audio data file from a plurality of stereophonic audio data files;
determine a first volume of the first audio generator and a second volume of the second audio generator based on the selected stereophonic audio data file; and
control the first audio generator to generate a first stereophonic audio output corresponding to the selected stereophonic audio file at the first volume and the second audio generator to generate a second stereophonic audio output corresponding to the selected stereophonic audio file at the second volume.

2. The commodity sales data processing apparatus according to claim 1, wherein
when the control device selects a first stereophonic audio data file, the control device determines the first volume to be a first level, and the second volume to be a second level less than the first level, and
when the control device selects a second stereophonic audio data file, the control device determines the first volume to be a third level, and the second volume to be a fourth level greater than the third level.

3. The commodity sales data processing apparatus according to claim 2, wherein
when the control device selects a third stereophonic audio data file, the control device determines both the first volume and the second volume to be a fifth level.

4. The commodity sales data processing apparatus according to claim 1, wherein
when the control device selects a first stereophonic audio data file, the control device determines the first volume to be an unmuted level, and the second volume to be a muted level, and
when the control device selects a second stereophonic audio data file, the control device determines the first volume to be a muted level, and the second volume to be an unmuted level.

5. The commodity sales data processing apparatus according to claim 4, wherein
when the control device selects a third stereophonic audio data file, the control device determines the first volume to be an unmuted level, and the second volume to be an unmuted level.

6. The commodity sales data processing apparatus according to claim 1, wherein at least one of the plurality of stereophonic audio data files indicates a first volume of the first audio generator and a second volume of the second audio generator corresponding thereto.

7. The commodity sales data processing apparatus according to claim 1, wherein
at least one of the plurality of stereophonic audio data files includes stereophonic audio data of a linguistic audio message, and
at least one of the plurality of stereophonic audio data files includes stereophonic audio data of a non-linguistic audio message.

8. The commodity sales data processing apparatus according to claim 1, further comprising:
an amplifier connected to the first and second stereophonic audio channels, and configured to amplify the first part of the stereophonic audio signal based on the first volume and the second part of the stereophonic audio signal based on the second volume.

9. The commodity sales data processing apparatus according to claim 1, wherein the first audio generator is a speaker, and the second audio generator is a speaker.

10. The commodity sales data processing apparatus according to claim 1, further comprising:
a first display directed toward the first side of the commodity sales data processing apparatus; and
a second display directed toward the second side of the commodity sales data processing apparatus.

11. A method for outputting an audio output comprising:
selecting a stereophonic audio data file from a plurality of stereophonic audio data files;
determining a first volume of a first part of a stereophonic audio signal corresponding to the selected stereophonic audio data file, and a second volume of a second part of the stereophonic audio signal;
transmitting the first part of the stereophonic audio signal through a first stereophonic audio channel and the second part of the stereophonic audio signal through a second stereophonic audio channel; and
generating a first stereophonic audio output corresponding to the first part of the stereophonic audio signal at the first volume from a first audio generator directed toward a first side of a commodity sales data processing apparatus, and a second stereophonic audio output corresponding to the second part of the stereophonic audio signal at the second volume from a second audio generator directed toward a second side of the commodity sales data processing apparatus different from the first side.

12. The method according to claim 11, wherein said determining comprises:
when a first stereophonic audio data file is selected, determining the first volume to be a first level, and the second volume to be a second level less than the first level, and
when a second stereophonic audio data file is selected, determining the first volume to be a third level, and the second volume to be a fourth level greater than the third level.

13. The method according to claim 12, wherein said determining further comprises:
when a third stereophonic audio data file is selected, determining both the first volume and the second volume to be a fifth level.

14. The method according to claim 11, wherein said determining comprises:
when a first stereophonic audio data file is selected, determining the first volume to be an unmuted level, and the second volume to be a muted level, and
when a second stereophonic audio data file is selected, determining the first volume to be a muted level, and the second volume to be an unmuted level.

15. The method according to claim 14, wherein said determining further comprises:
when a third stereophonic audio data file is selected, determining the first volume to be an unmuted level, and the second volume to be an unmuted level.

16. The method according to claim 11, wherein at least one of the plurality of stereophonic audio data files indicates a first volume of the first audio generator and a second volume of the second audio generator corresponding thereto.

17. The method according to claim 11, wherein
at least one of the plurality of stereophonic audio data files includes stereophonic audio data of a linguistic audio message, and
at least one of the plurality of stereophonic audio data files includes stereophonic audio data of a non-linguistic audio message.

18. The method according to claim 11, further comprising:
amplifying, with an amplifier connected to the first and second channels, the first part of the stereophonic audio signal based on the first volume and the second part of the stereophonic audio signal based on the second volume.

19. The method according to claim 11, wherein the first audio generator is a speaker, and the second audio generator is a speaker.

20. The method according to claim 11, wherein the first side is a cashier side and the second side is a customer side.
